(19) United States
(12) Patent Application Publication
(10) Pub. No.: US 2010/0177783 A1
(43) Pub. Date: Jul. 15, 2010

(54) Interface systems between media access control (MAC) and physical layer (PHY) including parallel exchange of PHY register data and address information, and methods of operating the parallel exchange

(75) Inventors: Ganesansathish Kumar, Yongin-si (KR); Jin Yong Chung, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/655,952

(22) Filed: Jan. 11, 2010

(30) Foreign Application Priority Data
Jan. 13, 2009 (KR) 10-2009-0002745
Oct. 20, 2009 (KR) 10-2009-0099816

(51) Int. Cl. H04L 12/40

(52) U.S. Cl. 370/438

(57) ABSTRACT

In a system and method of transferring signals between a media access controller (MAC) and a physical layer (PHY) the signals are transferred on an interface that includes a parallel data bus for the transmission of data signals in parallel between the MAC and the PHY. At the MAC, a PHY register transaction is initiated, by providing, at the MAC, a PHY register address in parallel on the parallel data bus and a control signal on a serial control signal line to request the PHY register transaction, the PHY register transaction comprising one of a PHY register write operation and a PHY register read operation. In the event the control signal requests a PHY register write operation, the MAC next provides PHY register data signals in parallel on the parallel data bus to program a PHY register having the PHY register address. In the event the control signal requests a PHY register read operation, the PHY next provides PHY register data signals in parallel on the parallel data bus for the PHY register having the PHY register address.

### RELATED APPLICATIONS

This application claims priority under 35 U.S.C. 119 to Korean Patent Application No. 2009-0002745, filed Jan. 13, 2009 and Korean Patent Application No. 2009-0099816, filed Oct. 20, 2009, the content of each being incorporated herein by reference in its entirety.

### BACKGROUND

Embodiments of the present inventive concept relate to an interface, and more particularly, to a MAC-PHY interface capable of using a serial mode or a parallel mode for effecting a PHY register operation, and operation methods thereof.

Wireless data transfer systems continue to become more and more significant with the ever-gaining popularity of wireless electronic devices. In particular wireless universal system bus (USB) systems enjoy widespread use.

In such systems, it is common for system components to include a media access controller (MAC) and a physical layer (PHY). The MAC controls operation of the system, while the physical layer contains the physical wireless communication systems that are operated under control of the MAC. The exchange of control signals and data signals between the MAC and PHY is controlled via a MAC-PHY interface (MPI)

Industry collaboration defines the operation of a wireless data transfer system, commonly in an agreed-upon specification. In one example widely accepted specification, MAC-PHY Interface Specification, WiMedia Alliance, Version 1.5, draft 3, incorporated herein by reference, a MAC-PHY interface is defined for a wireless USB system.

### SUMMARY

The present inventive concept provides a MAC-PHY interface capable of supporting a serial mode or a parallel mode for PHY register transactions, and operation methods thereof.

In one aspect, a method of transferring signals between a media access controller (MAC) and a physical layer (PHY) on an interface that includes a parallel data bus for the transmission of data signals in parallel between the MAC and the PHY, comprises: initiating, at the MAC, a PHY register transaction, by providing, at the MAC, a PHY register address in parallel on the parallel data bus and a control signal on a serial control signal line to request the PHY register transaction, the PHY register transaction comprising one of a PHY register write operation and a PHY register read operation; in the event the control signal requests a PHY register write operation, the MAC next providing PHY register data signals in parallel on the parallel data bus to program a PHY register having the PHY register address; and in the event the control signal requests a PHY register read operation, the PHY next providing PHY register data signals in parallel on the parallel data bus for the PHY register having the PHY register address.

In one embodiment, in the event the control signal requests a PHY register write operation, the MAC further provides a data control signal on the serial control line to indicate the availability of the PHY register data signals on the parallel data bus.

In another embodiment, in the event the control signal requests a PHY register read operation, the PHY further provides a data control signal on the serial control line to indicate the availability of the PHY register data signals on the parallel data bus.

In another embodiment, the control signal comprises a synchronization bit that indicates the initiation of a PHY register transaction, followed by a read/write bit that indicates whether the initiated PHY register transaction is a PHY register read operation or a PHY register write operation.

In another embodiment, the method further comprises before or during the step of initiating, in the event the control signal requests a PHY register write operation and it is determined that the parallel data bus is not available for a PHY register transaction, the MAC instead provides a control signal on a serial control signal line to request the PHY register write operation followed by providing the PHY register address in serial on the serial control signal line.

In another embodiment, the method further comprises, following the step of initiating, in the event the control signal requests a PHY register write operation and it is determined that the parallel data bus is no longer available for a PHY register transaction, the MAC continues providing a PHY register address in parallel on the parallel data bus and a control signal on a serial control signal line to request the PHY register write operation.

In another embodiment, the method further comprises, in the event the control signal requests a PHY register read operation and it is determined that the parallel data bus is not available for a PHY register transaction, the PHY register read operation is aborted, and the MAC continues by providing a control signal on the serial control signal line to request the PHY register read operation followed by providing the PHY register address in serial on the serial control signal line.

In another embodiment, in the event a mode of operation of the PHY register transaction is determined as a parallel mode, the PHY register address and the PHY register data are provided between the PHY and the MAC in parallel on the parallel data bus, and further, in the event the mode of operation of the PHY register transaction is determined as a serial mode, the PHY register address and the PHY register data are provided between the PHY and the MAC in serial on the serial control signal line.

In another embodiment, the mode of operation of the PHY register transaction is determined as a data value of at least one bit of at least one of the PHY registers.

In another embodiment, the PHY register address comprises eight bits and the parallel data bus is eight-bits wide.

In another embodiment, the PHY register data comprises eight bits and the parallel data bus is eight-bits wide.

In another aspect, a data transmission system including a media access controller (MAC) and a physical layer (PHY) that transfer signals on an interface comprises: a parallel data bus for the transmission of data signals in parallel between the MAC and the PHY; a serial control line for the transmission of control signals between the MAC and the PHY; and a controller configured to initiate, at the MAC, a PHY register transaction, by providing, at the MAC, a PHY register address in parallel on the parallel data bus and a control signal on the serial control signal line to request the PHY register transaction, the PHY register transaction comprising one of a PHY register write operation and a PHY register read operation, wherein in the event the control signal requests a PHY register write operation, the MAC next provides PHY register data signals in parallel on the parallel data bus to program a PHY register having the PHY register address; and in the event the control signal requests a PHY register read operation, the PHY next provides PHY register data signals in parallel on the parallel data bus for the PHY register having the PHY register address.

In one embodiment, in the event the control signal requests a PHY register write operation, the controller is further configured to have the MAC further provide a data control signal on the serial control line to indicate the availability of the PHY register data signals on the parallel data bus.

In another embodiment, in the event the control signal requests a PHY register read operation, the PHY further provides a data control signal on the serial control line to indicate the availability of the PHY register data signals on the parallel data bus.

In another embodiment, the control signal comprises a synchronization bit that indicates the initiation of a PHY register transaction, followed by a read/write bit that indicates whether the initiated PHY register transaction is a PHY register read operation or a PHY register write operation.

In another embodiment, the controller is further configured so that before or during the MAC initiating a PHY register transaction, in the event the control signal requests a PHY register write operation and it is determined that the parallel data bus is not available for a PHY register transaction, the MAC instead provides a control signal on a serial control signal line to request the PHY register write operation followed by providing the PHY register address in serial on the serial control signal line.

In another embodiment, the controller is further configured so that following the MAC initiating a PHY register transaction, in the event the control signal requests a PHY register write operation and it is determined that the parallel data bus is no longer available for a PHY register transaction, the MAC continues providing a PHY register address in parallel on the parallel data bus and providing a control signal on a serial control signal line to request the PHY register write operation.

In another embodiment, the controller is further configured so that, in the event the control signal requests a PHY register read operation and it is determined that the parallel data bus is not available for a PHY register transaction, the PHY register read operation is aborted, and the MAC continues by providing a control signal on the serial control signal line to request the PHY register read operation followed by providing the PHY register address in serial on the serial control signal line.

In another embodiment, in the event a mode of operation of the PHY register transaction is determined as a parallel mode, the controller is configured so that the PHY register address and the PHY register data are provided between the PHY and the MAC in parallel on the parallel data bus, and further in the event the mode of operation of the PHY register transaction is determined as a serial mode, the controller is configured so that the PHY register address and the PHY register data are provided between the PHY and the MAC in serial on the serial control signal line.

In another embodiment, the mode of operation of the PHY register transaction is determined as a data value of at least one bit of at least one of the PHY registers.

In another embodiment, the PHY register address comprises eight bits and the parallel data bus is eight-bits wide.

In another embodiment, the PHY register data comprises eight bits and the parallel data bus is eight-bits wide.

In another aspect, a method of transferring signals between a media access controller (MAC) and a physical layer (PHY) on an interface that includes a parallel data bus for the transmission of data signals in parallel between the MAC and the PHY and that includes a serial control line for the transmission of control signals between the MAC and PHY, comprises: setting a data value of at least one PHY register of the PHY to indicate one of a parallel mode and a serial mode of operation; and performing a PHY register transaction in parallel on the parallel data bus in response to the data value of the PHY interface register indicating a parallel mode of operation; and performing a PHY register transaction in serial on the serial control signal line in response to the data value of the PHY interface register indicating a serial mode of operation.

In one embodiment, the method further comprises: initiating, at the MAC, a PHY register transaction, by providing, at the MAC, a PHY register address in parallel on the parallel data bus and a control signal on the serial control signal line to request the PHY register transaction, the PHY register transaction comprising one of a PHY register write operation and a PHY register read operation; in the event the control signal requests a PHY register write operation, the MAC next providing PHY register data signals in parallel on the parallel data bus to program a PHY register having the PHY register address; and in the event the control signal requests a PHY register read operation, the PHY next providing PHY register data signals in parallel on the parallel data bus for the PHY register having the PHY register address.

In one embodiment, in the event the control signal requests a PHY register write operation, the MAC further provides a data control signal on the serial control line to indicate the availability of the PHY register data signals on the parallel data bus.

In another embodiment, in the event the control signal requests a PHY register read operation, the PHY further provides a data control signal on the serial control line to indicate the availability of the PHY register data signals on the parallel data bus.

In another embodiment, the control signal comprises a synchronization bit that indicates the initiation of a PHY register transaction, followed by a read/write bit that indicates whether the initiated PHY register transaction is a PHY register read operation or a PHY register write operation.

In another embodiment, the method further comprises before or during the step of initiating, in the event the control signal requests a PHY register write operation and it is determined that the parallel data bus is not available for a PHY register transaction, the MAC instead provides a control signal on a serial control signal line to request the PHY register write operation followed by providing the PHY register address in serial on the serial control signal line.

In another embodiment, the method further comprises, following the step of initiating, in the event the control signal requests a PHY register write operation and it is determined that the parallel data bus is no longer available for a PHY register transaction, the MAC continues providing a PHY register address in parallel on the parallel data bus and a control signal on a serial control signal line to request the PHY register write operation.

In another embodiment, the method further comprises, in the event the control signal requests a PHY register read operation and it is determined that the parallel data bus is not available for a PHY register transaction, the PHY register read operation is aborted, and the MAC continues by providing a control signal on the serial control signal line to request the PHY register read operation followed by providing the PHY register address in serial on the serial control signal line.

In another embodiment, in the event a mode of operation of the PHY register transaction is determined as a parallel mode, the PHY register address and the PHY register data are provided between the PHY and the MAC in parallel on the parallel data bus, and further, in the event the mode of operation of the PHY register transaction is determined as a serial mode, the PHY register address and the PHY register data are provided between the PHY and the MAC in serial on the serial control signal line.

In another embodiment, the PHY register address comprises eight bits and the parallel data bus is eight-bits wide.

In another embodiment, the PHY register data comprises eight bits and the parallel data bus is eight-bits wide.

### BRIEF DESCRIPTION OF THE DRAWINGS

The foregoing and other objects, features and advantages of the embodiments of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention. In the drawings:

FIG. 1 is a schematic block diagram of a wireless data transfer system including a MAC-PHY interface according to an example embodiment of the present invention;

FIG. 2 is a timing diagram of a serial read operation of a PHY register transaction of the wireless data transfer system illustrated in FIG. 1;

FIG. 3 is a timing diagram of a serial write operation of a PHY register transaction of the wireless data transfer system illustrated in FIG. 1;

FIG. 4 is a timing diagram of a serial write operation after a serial read operation of a PHY register transaction of the wireless data transfer system illustrated in FIG. 1;

FIG. 5 is a timing diagram of a parallel read operation of a PHY register transaction of the wireless data transfer system illustrated in FIG. 1;

FIG. 6 is a timing diagram of a parallel write operation of a PHY register transaction of the wireless data transfer system illustrated in FIG. 1;

FIG. 7 is a timing diagram of a first write operation in parallel mode of a PHY register transaction of the PHY system by the MAC system, followed by an attempt at a second write operation in parallel mode that is aborted and instead performed in serial mode, in the wireless data transfer system illustrated in FIG. 1.

FIG. 8 is a timing diagram of a first read operation in parallel mode of a PHY register transaction of the PHY system by the MAC system, that is aborted and instead performed in serial mode, in the wireless data transfer system illustrated in FIG. 1.

FIG. 9 is a flow diagram illustrating switching between operational register management in parallel mode and an serial mode.

### DETAILED DESCRIPTION OF EMBODIMENTS

Embodiments of the present invention will now be described more fully hereinafter with reference to the accompanying drawings, in which preferred embodiments of the invention are shown. This invention may, however, be embodied in different forms and should not be construed as limited to the embodiments set forth herein. Like numbers refer to like elements throughout the specification.

It will be understood that, although the terms first, second, etc. are used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

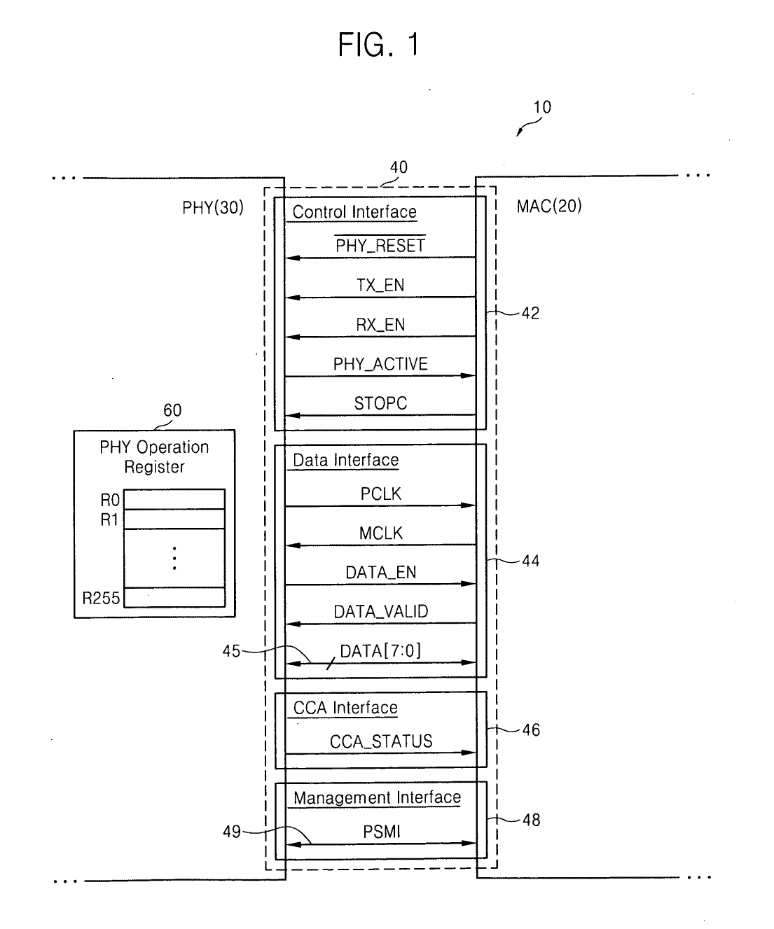

FIG. 1 is a schematic block diagram of a wireless data transfer system including a MAC-PHY interface according to an example embodiment of the present invention.

Referring to FIG. 1, a wireless data transfer system 10 includes a medium access control system unit (MAC) 20, a physical layer system unit PHY 30, and an interface unit, or a MAC-PHY interface unit 40 connected between the MAC system 20 and the PHY system 30. The wireless data transfer system 10 according to embodiments of the present invention may be part of a computer system, a laptop computer system, a personal data assistant system (PDA), a portable media player (PMP) system, or other suitable portable electronic device systems.

According to embodiments, the wireless data transfer system 10 may be embodied as an integrated semiconductor chip or a System on Chip (SoC). Alternatively, in another embodiment, the MAC system 20 and the PHY system 30 may be respectively embodied as separate semiconductor chips. In this case, a MAC-PHY interface 40 may be embodied in either or both chips to enable communication between the separate chips.

A MAC-PHY interface 40 commonly includes a control interface 42, a data interface 44 including a N-bit data bus 45, where N is a natural number, for example N=8, a clear channel assessment CCA interface 46, and a management interface 48 including a PSMI line 49.

The control interface 42 includes a plurality of interface signals for controlling the operation of the PHY system 30. These signals include a PHY reset signal !PHY_RESET, which initiates a reset operation of the PHY system 30, a transmission enable signal TX_EN, which is used to place the PHY system 30 in a data transmit state, a receive enable signal RX_EN, which is used to place the PHY system 30 in a data receive state, a PHY active signal PHY_ACTIVE, which is a handshaking signal used by the PHY system 30 to instruct the MAC system 20 that a data transmit or data receive frame is active, and an on/off signal STOPC, which is used to place the PHY system in an ON or OFF state. The !PHY_RESET, TX_EN, RX_EN, PHY_ACTIVE, and STOPC signals are commonly single-bit signals that are transferred on single signal lines.

In further detail, the PHY reset signal !PHY_RESET is used to clear all variables of the PHY system 30 and for resetting the PHY system 30 to an initial state. The !PHY_RESET signal is output from the MAC system 20 to the PHY system 30, and is asynchronous relative to a first clock signal PCLK and a second clock signal MCLK. In one embodiment, the PHY reset signal !PHY_RESET is active low.

The transmission enable signal TX_EN is used for placing the PHY system 30 in a transmit state, and is transmitted from the MAC system 20 to the PHY system 30. The transmission enable signal TX_EN is synchronized with the second clock signal MCLK other than when system operation is in a sleep state. In one embodiment, the transmission enable signal TX_EN is active high.

The receive enable signal RX_EN is used for placing the PHY system 30 in a receive state, and is transmitted from the MAC system 20 to the PHY system 30. The receive enable signal RX_EN is synchronized with the second clock signal MCLK other than when system operation is in a sleep state. In one embodiment, the receive enable signal RX_EN is active high.

As mentioned above, the PHY active signal PHY_ACTIVE, is a handshaking signal used by the PHY system 30 to instruct the MAC system 20 that a data transmit or data receive frame is active. A rising edge of the PHY active signal PHY_ACTIVE during operation in a transmit state indicates that transmission of a frame is initiated over the air from the local antenna. A falling edge of the PHY active signal PHY_ACTIVE during operation in a transmit state indicates that the entire frame has been transmitted over the air from the local antenna. In addition, a rising edge of the PHY active signal PHY_ACTIVE during operation in a receive state indicates that a start of preamble period is detected, while a falling edge of the PHY active signal PHY_ACTIVE indicates that entire frame is received at the local antenna. The PHY active signal PHY_ACTIVE can synchronized to a first clock signal PCLK that is generated by the PHY system 30. In one embodiment, the PHY active signal PHY_ACTIVE is active high. The PHY active signal PHY_ACTIVE can be used in the event of an exit from a sleep state and from a reset state.

The on/off signal STOPC indicates an on/off state, or an on/off transmission state, of the first clock signal PCLK during operation in a standby mode. When the on/off signal STOPC is not output from the MAC system 20 to the PHY system 30, or in other words, when the on/of signal STOPC is inactive, the first clock signal PCLK becomes active. When the on/off signal STOPC is output to the PHY system 30, or in other words, when the on/off signal STOPC is active, the first clock signal PCLK is not made to be active. The on/off signal STOPC is optional for system operation and is asynchronous with respect to the first clock signal PCLK and the second clock signal MCLK. In one embodiment, the on/off signal STOPC is active high.

The data interface 44 includes a plurality of interface signals for controlling the exchange of data between the MAC system 20 and the PHY system 30. These signals include a first clock signal PCLK, which is a clock signal generated by the PHY system 30 for synchronizing the exchange of data from the PHY system 30 to the MAC system 20, a second clock signal MCLK, which is a clock signal generated by the MAC system 20 for synchronizing the exchange of data from the MAC system 20 to the PHY system 30, a data enable signal DATA_EN transmitted by the PHY system 30 to indicate to the MAC system 20 that data is available on the parallel data bus DATA[7:0], a data valid signal DATA_VALID transmitted by the MAC system 20 to indicate to the PHY system 30 that data is available on the parallel data bus DATA[7:0], and a bidirectional parallel data bus DATA[7:0] 45 on which data are exchanged in parallel between the MAC system 20 and the PHY system 30 during normal data transmission and receive operations. In embodiments of the present invention, PHY register transactions can also be performed on the bidirectional parallel data bus DATA[7:0], whereby PHY register address and PHY register data information are transmitted on the bidirectional parallel data bus DATA[7:0] in parallel, as will be described in further detail below. The PCLK, MCLK, DATA_EN, and DATA_VALID signals are commonly single-bit signals that are transferred on single signal lines.

In further detail, the first clock signal PCLK output from the PHY system 30 to the MAC system 20 is an interface clock signal supplied by the PHY system 30. Interface signals output by the PHY system 30 are synchronized with an edge, for example a rising edge, of the first clock signal PCLK. The second clock signal MCLK output from the MAC system 20 to the PHY system 30 is an interface clock signal supplied by the MAC system 20. Interface signals output by the MAC system 20 are synchronized with an edge, for example a rising edge, of the second clock signal MCLK.

The data enable signal DATA_EN output from the PHY system 30 to the MAC system 20 is used to request more data for transmission from the MAC system 20 during operation in a transmit state and to indicate to the MAC 20 that valid data is present on the data bus 45 during operation in a receive state. The data enable signal DATA_EN is synchronized with the first clock signal PCLK. In one embodiment, the data enable signal DATA_EN is active high.

The data valid signal DATA_VALID output from the MAC system 20 to the PHY system 30 is used to indicate to the PHY system 30 that valid data is present on the data bus for transmission during operation in a transmit state. The data valid signal DATA_VALID is synchronized to the second clock signal MCLK. In one embodiment, the data valid signal DATA_VALID is active high.

The bidirectional parallel data bus DATA[7:0] 45 is driven by the MAC system 20 during operation in a transmit state, and is driven by the PHY system 30 during operation in a receive state. When the data bus 45 is driven by the PHY system 30, parallel data transmitted through the data bus DATA[7:0] 45, is transmitted to the MAC system 20 in response to the first clock signal PCLK. When the data bus 45 is driven by the MAC system 20, parallel data transmitted through the data bus DATA[7:0] 45 is transmitted to the PHY system 30 in response to the second clock signal MCLK. In one embodiment, a data element “1” is a high signal and data element “0” is a low signal. The second clock signal MCLK generated by the MAC 20, in one embodiment, can be a delayed version of the first clock signal PCLK.

The clear channel assessment interface 46 includes a CCA state indicating signal CCA_STATUS that is used by the PHY system 30. A clear channel assessment algorithm is implemented in the PHY system 30. During the reception of data, the MAC system 20 can enable or disable the CCA algorithm to estimate the CCA of the receiving channel. In one embodiment, the PHY system 30 includes three types of registers; namely, static registers which are unchanged during operation, dynamic registers which can change during operation, and vendor specific registers which are defined by the user. In the event that operation of the CCA algorithm is desired, the MAC system 20 can enable the operation of the CCA algorithm in the PHY system 30 by setting one of the dynamic registers, in one example, a CCRE field of the CONTROL register of the dynamic registers. When the CCA estimation algorithm is active, and if the estimation value is valid, the PHY system 30 can return a CCS_STATUS signal as active, meaning the CCA estimation is valid. The resultant estimation values of the CCA algorithm can be provided and updated in the vendor specific registers, which can be uploaded to the MAC system through a PHY register transaction, namely a PHY register read operation, according to the systems and methods described herein.

The CCA state indicating signal CCA_STATUS is commonly a single-bit signal that is synchronized with the first clock signal PCLK. In one embodiment, the CCA state indicating signal CCA_STATUS is active high. The CCA_STATUS signal is commonly a single-bit signal that is transferred on a single signal line.

The management interface 48 includes a parallel/serial management interface signal PSMI. The parallel/serial management interface signal PSMI is a bidirectional signal that is used by the MAC system 20 for writing program information to, and for retrieving status information from, a plurality of operation registers 60, for example, control and configuration registers located in the PHY system 30. It is through these operation registers 60 that operation of the PHY system 30 is controlled and monitored by the MAC system 20. The PSMI signal is commonly a single-bit signal that is transferred on a single signal line.

A plurality of operation registers 60 are commonly included in the PHY system, for example, 256 registers R0 . . . R255. The registers R0 . . . R255 are individually addressable by control logic present on the PHY system, enabling the MAC system 20 to have access to each independent register R0 . . . R255 for programming and status retrieval purposes. The registers are commonly multiple bits is size, for example eight bits in size. In other embodiments, the registers can be of fewer number of bits in size, for example four bits in size, or of greater number of bits in size, for example sixteen or thirty-two bits in size.

At certain time periods of operation, such as following a system power loss, following operation in a system sleep mode, or following a reset operation, the operation registers 60 of the PHY system 30 require initialization or management. To initialize an operation register 60 or other vendor-specific register of the PHY system 30, the MAC system 20 can perform an operation, referred to herein as a PHY register transaction, such as an initializing PHY register write operation, to write register data, or write data, to the appropriate operation register 60. Alternatively, in another PHY register transaction, a PHY register read operation can be performed by the MAC system 20 to read the contents of an operation register 60, or read data. In a case where the PHY register write operation or PHY register read operation is performed on an operation register 60 during an initialization sequence, the PHY register write operation can be referred to as an initializing write operation and the PHY register read operation can be referred to as an initializing read operation.

In embodiments of the present invention, the programming, or write, operation and status retrieval, or read, PHY register operation of the PHY system operational registers 60 can be performed in either a serial mode or in a parallel mode.

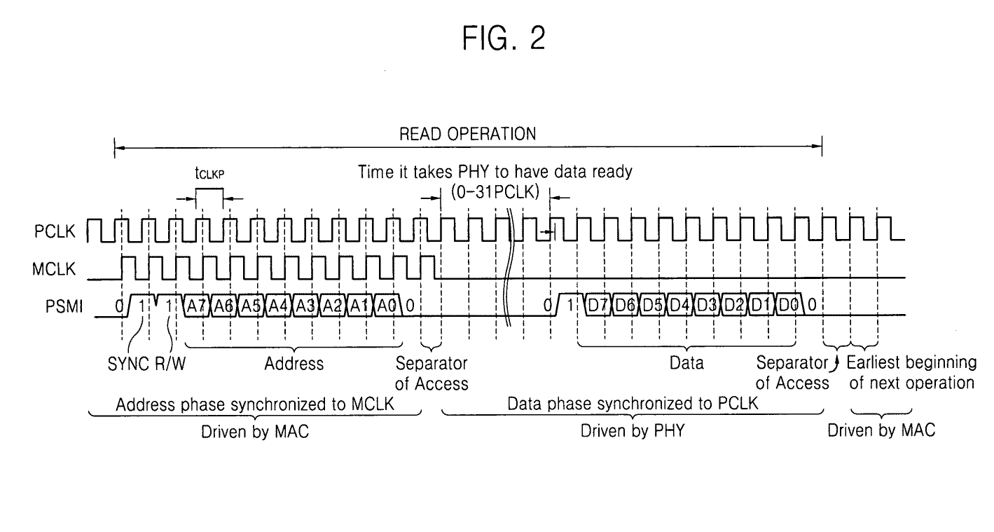

When programming and status retrieval operations of the operational registers 60 is performed in a serial mode, all address and data exchanges are performed via the PSMI signal 49, one bit at a time. In this case, the PSMI signal is used as both a control signal for handshaking purposes between the MAC system 20 and the PHY system 30, and is used for the transfer of operation register address and operational register data information between the MAC system 20 and the PHY system 30. Such exchange of address and data information during operation in the serial mode, one bit at a time, will be explained in greater detail below, with reference to the timing diagrams of FIGS. 2-4.

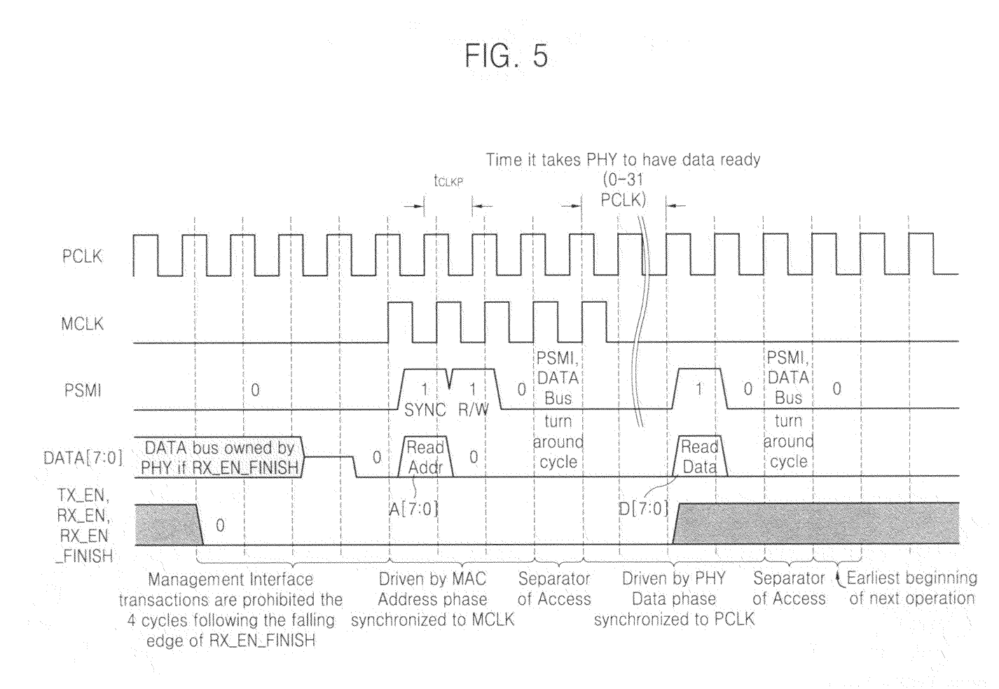

When programming and status retrieval operations of the operational registers 60 of the PHY system 30 is performed in a parallel mode, handshaking and control of the exchange are performed via the serial PSMI signal 49; however, in the parallel case, all register address and register data exchanges are performed on the parallel data bus DATA[7:0]. This enables more efficient programming of the operational registers 60 by the MAC system 20, and more efficient status retrieval of the operational registers 60 by the MAC system 20, since the operational register data and operational register address information are transmitted in parallel. Although the parallel data bus DATA[7:0] is described herein as an eight-bit data bus, embodiments of the present invention are equally compatible with data busses of other sizes for example, two-bit, four-bit and sixteen-bit data bus sizes. Such exchange of address and data information during operation in the parallel mode, multiple bits at a time, will be explained in greater detail below, with reference to the timing diagrams of FIGS. 5-7.

In certain embodiments, a determination of parallel or serial mode of programming and status retrieval of the operational registers 60 can be controlled in response to a data element of one of the operational registers 60.

As described above, in one example, the PHY system 30 includes three types of operational registers 60; namely, static registers which are unchanged during operation, dynamic registers which can change during operation, and vendor specific registers which are defined by the user. Static registers, also referred to as PHY capability registers, can be PHY system 30 dependent values that are fixed and not changed during operation. Dynamic registers are used for operations and are commonly programmed before an operation takes place, for example prior to a transmit or receive operation, to cause the PHY system 30 to behave accordingly. Vendor specific registers are additional register space made available to user purposes, for example for CCA estimation purposes.

In one example embodiment, one of the dynamic MPI CONFIG registers of the operational registers 60 can be appropriately set to command the management interface 48 to operate in the parallel mode or serial mode. For example, depending on the setting of an MPI capabilities register, as one of the MPI CONFIG registers, defining a static parameter, a parallel or serial mode can be commanded.

In one example, the MPI capabilities register may be embodied as an eight-bit register. A first bit of the MPI capabilities register, i.e., bit [0], can be set to 1 for supporting an input of the second clock signal MCLK. In the event the PHY system 30 is DDR capable, a second bit of the MPI capabilities register, i.e., bit [1], can be set to 1. In the event the PHY system 30 is parallel-mode capable, a third bit of the MPI capabilities register, i.e., bit [2], can be set to 1. The remaining bits [7:3] of the MPI capabilities register can be reserve bits, or otherwise used for other purposes.

A serial mode of programming and status retrieval of the operational registers 60 will now be described with reference to FIGS. 2-4. As described above, in the serial mode, the MAC system 20 and the PHY system 30 transmit and receive serial data via the PSMI line 49 as illustrated in FIGS. 2 to 4. The MAC system 30 during a PHY register transaction in a serial mode writes control bits and address bits on the management interface 48, for example on the PSMI line 49 line of the management interface, to initiate a PHY system 30 operational register 60 access. The MAC system 20 drives the PSMI line 49 with data to perform write operations in a serial manner, one bit at a time. When a operational register read operation is initiated, the PHY system 30 drives the PSMI line 49 with read data in a serial manner, one bit at a time.

FIG. 2 is a timing diagram of a read operation in serial mode of the operational registers 60 of the PHY system 30 by the MAC system 20 in the system illustrated in FIG. 1. Referring to FIG. 2, the MAC system 20 drives a first part of the transaction, namely the “address phase”, by delivering the address A[7:0] of the operational register 60 of the PHY system 30 to be accessed. The first part of the transaction is synchronized with the second clock signal MCLK generated by the MAC system 20. The PHY system 30 drives a second part of the transaction, namely the “data phase”, by delivering the requested data D[7:0] contained in the operational register 60 of the PHY system that was accessed by the address A[7:0]. The second part of the transaction is synchronized with the first clock signal PCLK generated by the PHY system 30.

At the start of the address phase of the read operation in serial mode, the MAC system 20, during a first clock cycle of the MCLK clock, first outputs a “1” on the PSMI line 49 as a first synchronization bit SYNC. The MAC system 30 next, during a next clock cycle of the MCLK clock, outputs a “1” on the PSMI line 49 as a second read/write bit R/W indicating that a read operation is requested. During the next eight clock cycles of the MCLK clock, the MAC system 20 outputs a PHY system 30 operational register 60 address A[7:0] on the PSMI line 49 serially, one address bit per clock cycle at a time. During the next clock cycle of the MCLK clock, the MAC 20 drives a ‘0’ bit on the PMSI line 49 for placing the PSMI line 49 in a known state, for example, to indicate termination of the address phase of the read operation of the operational register 60.

Continuing to refer to FIG. 2, the PHY system 20 responds by preparing the data requested by the MAC system; namely the PHY system prepares the contents of the operational register requested by the address A[7:0]. In one embodiment, this process can take up to 31 clock cycles of the PCLK clock. Accordingly, the PHY system 30 drives a ‘0’ bit on the PSMI line 49 for a period from 0 PCLK clock cycles 0*t_{CLKP} to 31 PCLK clock cycles 31*t_{CLKP} before transmitting the contents of the addressed operational register 60 as serial data D[7:0] to the MAC 20. When the register data, or register content, is available, the PHY system 30 drives a ‘1’ bit on the PMSI line 49 for indicating the start of serial data D[7:0]. During the next eight clock cycles of the PCLK clock, serial data D[7:0] is transmitted on the PSMI line 49 by the PHY system 20 to the MAC system 30 serially, one data bit per clock cycle at a time. When the process is completed, the PHY system 30 drives a terminating ‘0’ bit on the PMSI line 49, to indicate to the MAC system 30 that the PMSI line 49 is released to the MAC system, and to place the PMSI line 49 in a known state. Following this, a next operation can occur.

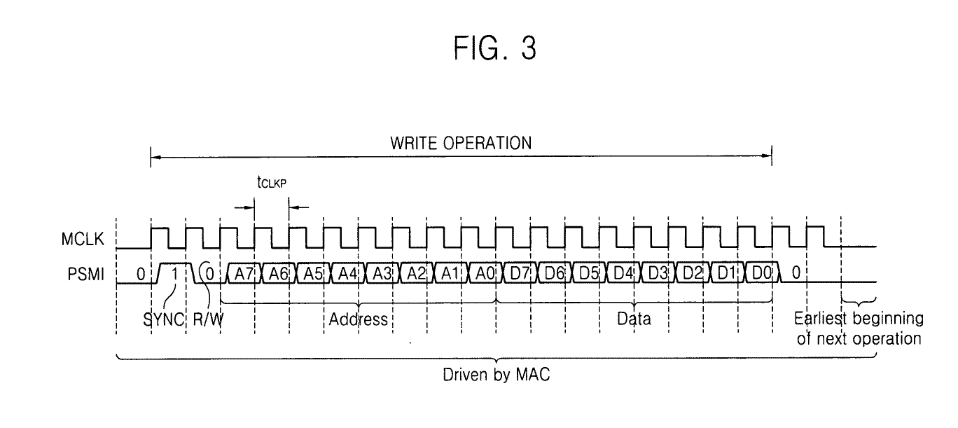

FIG. 3 is a timing diagram of a write operation in serial mode of the operational registers 60 of the PHY system 30 by the MAC system 20 in the system illustrated in FIG. 1. Referring to FIG. 3, the MAC system 20 drives a first part of the transaction, namely the “address phase”, by delivering the address A[7:0] of the operational register 60 of the PHY system 30 to be accessed. The first part of the transaction is synchronized with the second clock signal MCLK generated by the MAC system 20. The MAC system 30 also drives a second part of the transaction, namely the “data phase”, by delivering the data D[7:0] to be programmed in the operational register 60 of the PHY system that was accessed by the address A[7:0]. The second part of the transaction is also synchronized with the second clock signal MCLK generated by the MAC system 20. In this manner, for a write operation of an operational register 60 of the PHY system 30, both the first part and second part are under control of the MAC system 20 and both the first part and the second part are synchronized with the second clock signal MCLK generated by the MAC.

At the start of the address phase of the write operation in serial mode, the MAC system 20, during a first clock cycle of the MCLK clock, first outputs a “1” on the PSMI line 49 as a first synchronization bit SYNC. The MAC system 30 next, during a next clock cycle of the MCLK clock, outputs a “0” on the PSMI line 49 as a second read/write bit R/W indicating that a write operation is requested. During the next eight clock cycles of the MCLK clock, the MAC system 20 outputs a PHY system 30 operational register 60 address A[7:0] on the PSMI line 49 serially, one address bit per clock cycle at a time. Immediately following the address A[7:0], during the next eight clock cycles of the MCLK clock, the MAC system 20 outputs serial data D[7:0] on the PSMI line 49 to the PHY system 20, one data bit per clock cycle at a time. When the process is completed, the MAC system 20 drives a terminating ‘0’ bit on the PMSI line 49, to place the PMSI line 49 in a known state. Following this, a next operation can occur.

In any of the embodiments described herein, when the MAC system 30 is no longer driving a signal on the PMSI line 49, internal or external pull-down resistors may be employed to set the PMSI line to a known low, or “0”, state. Alternatively, the PSMI line 49 may be controlled continuously by the MAC 20 so as to transmit a known “0” state on the PMSI line 49 between PHY register transactions.

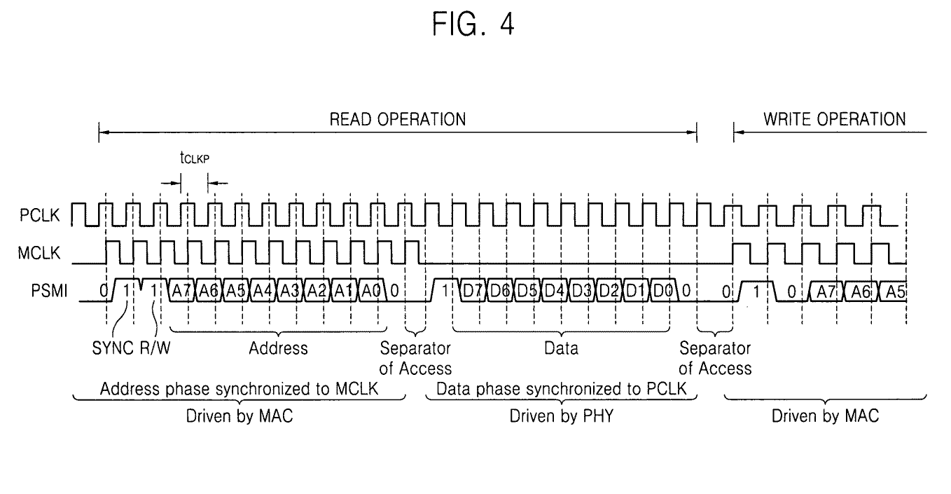

FIG. 4 is a timing diagram of a read operation in serial mode of the operational registers 60 of the PHY system 30 by the MAC system 20, followed by a write operation in serial mode of the operational registers 60 of the PHY system 30 by the MAC system 20 for the system illustrated in FIG. 1. In this example, it can be seen that following a serial read operation of the operational registers 60, a serial write operation of the operational registers 60 can be initiated.

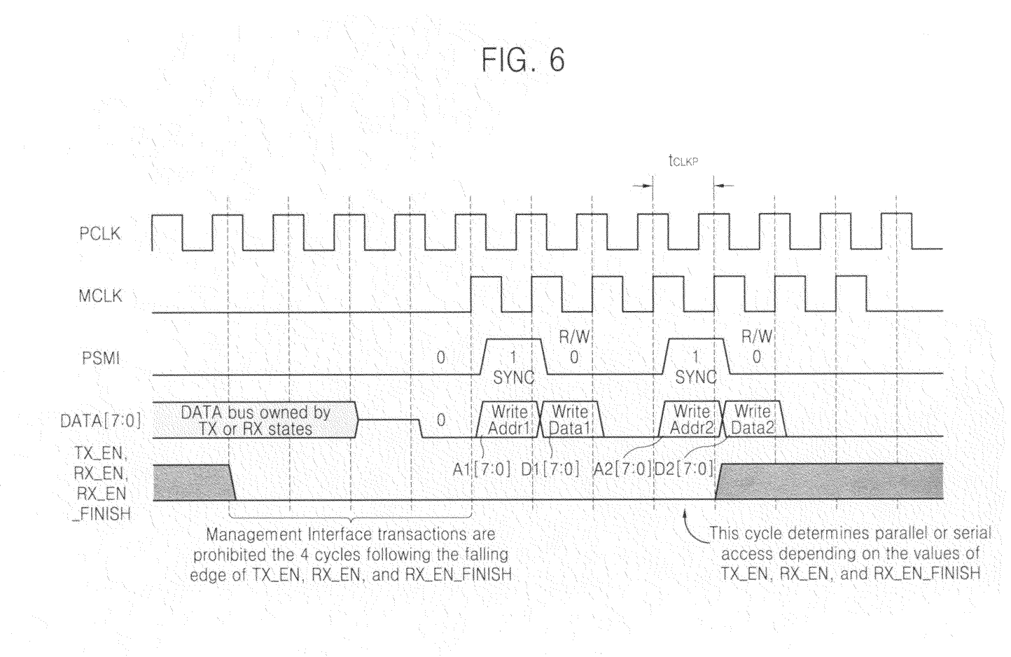

A parallel mode of performing a PHY register transaction, including programming and status retrieval of the operational registers 60, will now be described with reference to FIGS. 5 and 6. As described above, in the parallel mode, the MAC system 20 and the PHY system 30 transmit and receive PHY register address signals and PHY register data signals in parallel on the parallel data bus DATA [7:0]. In this case, handshaking and control signals between the MAC system 20 and the PHY system 30 can still be transferred using the existing PSMI line 49. The MAC system 30 when operating in a parallel mode writes address information on the DATA bus DATA [7:0] of the data interface 44, in coordination with control bits placed on the PSMI line 49 of the management interface 48, to initiate a PHY system 30 operational register 60 access. The MAC system 20 drives the data bus DATA [7:0] with parallel data while driving the PSMI line 49 with serial control signals to perform a write operations in a parallel manner, multiple bits at a time, or multiple bits per clock cycle. When a operational register read operation is initiated, the PHY system 30 responds by driving the data bus DATA [7:0] with parallel data while driving the PSMI line 49 with serial control signals.

FIG. 5 is a timing diagram of a read operation in parallel mode of the operational registers 60 of the PHY system 30 by the MAC system 20 in the system illustrated in FIG. 1. Referring to FIG. 5, the MAC system 20 drives a first part of the transaction, namely the “address phase”, by delivering the address A[7:0] of the operational register 60 of the PHY system 30 to be accessed. The first part of the transaction is synchronized with the second clock signal MCLK generated by the MAC system 20. The PHY system 30 drives a second part of the transaction, namely the “data phase”, by delivering the requested data D[7:0] contained in the operational register 60 of the PHY system that was accessed by the address A[7:0]. The second part of the transaction is synchronized with the first clock signal PCLK generated by the PHY system 30. During operation in the parallel mode, the address A[7:0] of the operational register 60 of the PHY system 30 to be accessed and the requested data D[7:0] contained in the operational register 60 of the PHY system that was accessed by the address A[7:0] are transferred between the MAC system 20 and the PHY system 30 in parallel, multiple bits at a time, on the data bus DATA [7:0] of the data interface 40.

At the start of the address phase of the read operation in parallel mode, it must be first determined whether the data bus DATA [7:0] is available to the management interface unit 48. In one embodiment, this determination can be made in response to the status of a RX_EN_FINISH signal transferred from the PHY system 30 to the MAC system 20. In this example, while the RX_EN_FINISH signal is maintained at a high level, the data bus 45 is owned by the PHY system 20. Accordingly, management interface transactions are prohibited by the MAC system 20 during four PCLK clock cycles 4*PCLK following a falling edge of the RX_EN_FINISH signal. Thus, the MAC 20 is prevented from initiating a read operation or a write operation of the operational registers 60 of the PHY system 30 transaction for four cycles of the PCLK clock from the falling edge of the RX_EN_FINISH signal.

Assuming the data bus DATA [7:0] is available to the MAC system 20, during a first clock cycle of the MCLK clock, the MAC system 30 first outputs a “1” on the PSMI line 49 as a first synchronization bit SYNC. At the same time, during the same MCLK clock cycle, the MAC system 20 also outputs a PHY system 30 operational register 60 address A[7:0] on the data bus DATA [7:0]. In this example, the entire eight bit address A[7:0] is transmitted during the same MCLK clock cycle, in parallel. The MAC system 30 next, during a next clock cycle of the MCLK clock, outputs a “1” on the PSMI line 49 as a second read/write bit R/W indicating that a read operation is requested. During the next clock cycle of the MCLK clock, the MAC 20 drives a ‘0’ bit on the PMSI line 49 for placing the PSMI line 49 in a known state, for example, to indicate termination of the address phase of the read operation of the operational register 60.

Continuing to refer to FIG. 5, the PHY system 20 responds by preparing the data requested by the MAC system; namely the PHY system prepares the contents of the operational register requested by the address A[7:0]. In one embodiment, this process can take up to 31 clock cycles of the PCLK clock. Accordingly, the PHY system 30 drives a ‘0’ bit on the PSMI line 49 for a period from 0 PCLK clock cycles 0*t_{CLKP} to 31 PCLK clock cycles 31*t_{CLKP} before transmitting the contents of the addressed operational register 60 as data D[7:0] to the MAC 20 in parallel. When the data is available, the PHY system 30 drives a ‘1’ bit on the PMSI line 49 for indicating the availability of data D[7:0]. At the same time, during the same PCLK clock cycle, data D[7:0] is output on the data bus DATA [7:0] by the PHY system 30 to the MAC system 20. In this example, the entire eight bit data D[7:0] is transmitted during the same PCLK clock cycle, in parallel. At the next cycle of the PCLK clock, the PHY system 30 drives a terminating ‘0’ bit on the PMSI line 49, to indicate to the MAC system 20 that the PMSI line 49 is released to the MAC system, and to place the PMSI line 49 in a known state. Following this, a next operation can occur.

FIG. 6 is a timing diagram of a write operation in parallel mode of the operational registers 60 of the PHY system 30 by the MAC system 20 in the system illustrated in FIG. 1. Referring to FIG. 6, the MAC system 20 drives a first part of the transaction, namely the “address phase”, by delivering the address A[7:0] of the operational register 60 of the PHY system 30 to be accessed. The first part of the transaction is synchronized with the second clock signal MCLK generated by the MAC system 20. The MAC system 30 also drives a second part of the transaction, namely the “data phase”, by delivering the data D[7:0] to be programmed in the operational register 60 of the PHY system that was accessed by the address A[7:0]. The second part of the transaction is also synchronized with the second clock signal MCLK generated by the MAC system 20. In this manner, for a write operation of an operational register 60 of the PHY system 30, both the first part and second part are under control of the MAC system 20 and both the first part and the second part are synchronized with the second clock signal MCLK generated by the MAC. During a write operation in the parallel mode, the address A[7:0] of the operational register 60 of the PHY system 30 to be accessed and the control data D[7:0] to be programmed in the operational register 60 of the PHY system as accessed by the address A[7:0] are transferred from the MAC system 20 and the PHY system 30 in parallel, on the data bus DATA [7:0] of the data interface 40.

At the start of the address phase of the write operation in parallel mode, like the read operation, it must be first determined whether the data bus DATA [7:0] is available to the management interface unit 48. In one embodiment, this determination can be made in response to the status of a TX_EN, RX_EN, and RX_EN_FINISH signals transferred between the PHY system 30 and the MAC system 20. In this example, while any of the TX_EN, RX_EN, and RX_EN_FINISH signals is maintained at a high level, the data bus 45 is owned by the PHY system 20 for data transfer. Accordingly, management interface transactions are prohibited by the MAC system 20 during four PCLK clock cycles 4*PCLK following a falling edge of any of the TX_EN, RX_EN, and RX_EN_FINISH signals. Thus, the MAC 20 is prevented from initiating a read operation or a write operation of the operational registers 60 of the PHY system 30 transaction for four cycles of the PCLK clock from the falling edge of any of the TX_EN, RX_EN, and RX_EN_FINISH signals

Assuming the data bus DATA [7:0] is available to the MAC system 20 for an operational register 60 write operation, during a first clock cycle of the MCLK clock, the MAC system 30 first outputs a “1” on the PSMI line 49 as a first synchronization bit SYNC that operates as an address enable indicator bit to the PHY system 30 for the write operation. At the same time, during the same MCLK clock cycle, the MAC system 20 also outputs a PHY system 30 operational register 60 first address A1[7:0] on the data bus DATA [7:0]. In this example, the entire eight bit first address A1[7:0] is transmitted during the same MCLK clock cycle, in parallel. The MAC system 30 next, during a next clock cycle of the MCLK clock, outputs a “0” on the PSMI line 49 as a first read/write bit R/W indicating that a write operation is requested. At the same time, during the same MCLK clock cycle, the MAC system 20 also outputs first operational register data D1[7:0] on the data bus DATA [7:0]. In this example, the entire eight bit first operational register data D1[7:0] is transmitted during the same MCLK clock cycle, in parallel.

During the next clock cycle of the MCLK clock, the MAC 20 drives a ‘0’ bit on the PMSI line 49 for placing the PSMI line 49 in a known state, for example, to indicate termination of the write operation of the operational register 60. The PHY system 30 responds by writing the received first operational register data D1[7:0] to the operation register 60 having the first address A1[7:0].

Continuing to refer to FIG. 6, assuming the data bus DATA [7:0] remains available to the MAC system 20 for an operational register 60 write operation, during a next clock cycle of the MCLK clock, the MAC system 30 first outputs a “1” on the PSMI line 49 as a second synchronization bit SYNC. At the same time, during the same MCLK clock cycle, the MAC system 20 also outputs a PHY system 30 operational register 60 second address A2[7:0] on the data bus DATA [7:0]. In this example, the entire eight bit second address A2[7:0] is transmitted during the same MCLK clock cycle, in parallel. The MAC system 30 next, during a next clock cycle of the MCLK clock, outputs a “0” on the PSMI line 49 as a second read/write bit R/W indicating that a write operation is requested. At the same time, during the same MCLK clock cycle, the MAC system 20 also outputs second operational register data D2[7:0] on the data bus DATA [7:0]. In this example, the entire eight bit second operational register data D2[7:0] is transmitted during the same MCLK clock cycle, in parallel.

During the next clock cycle of the MCLK clock, the MAC 20 drives a ‘0’ bit on the PMSI line 49 for placing the PSMI line 49 in a known state, for example, to indicate termination of the write operation of the operational register 60. The PHY system 30 responds by writing the received second register data D2[7:0] to the operational register 60 having the second address A2[7:0].

Referring back to FIG. 5, it can be seen that the operational register read operation in parallel mode can take place in as little as six cycles of the PCLK clock, in a best-case scenario that assumes immediate availability of the operational register data of the addressed register by the PHY system 30. This is compared to the need for twenty-two clock cycles that are consumed for an operational register read operation in serial mode under the best-case scenario. Also, it can be seen that the operational register read operation in parallel mode can take place in as little as thirty-six cycles of the PCLK clock, in a worst-case scenario that assumes availability of the operational register data of the addressed register by the PHY system after the transition of the permitted thirty-one cycles of the PCLK clock. This is compared to the need for fifty-two clock cycles that are consumed for an operational register read operation in serial mode under the worst-case scenario.

Referring to FIG. 6, it can be seen that the operational register write operation in parallel mode can take place in as little as two cycles of the PCLK clock. One clock cycle is consumed for the address phase of the write operation and one clock cycle is consumed for the data phase of the write operation. This is compared to the need for nineteen clock cycles that are consumed for an operational register write operation in serial mode.

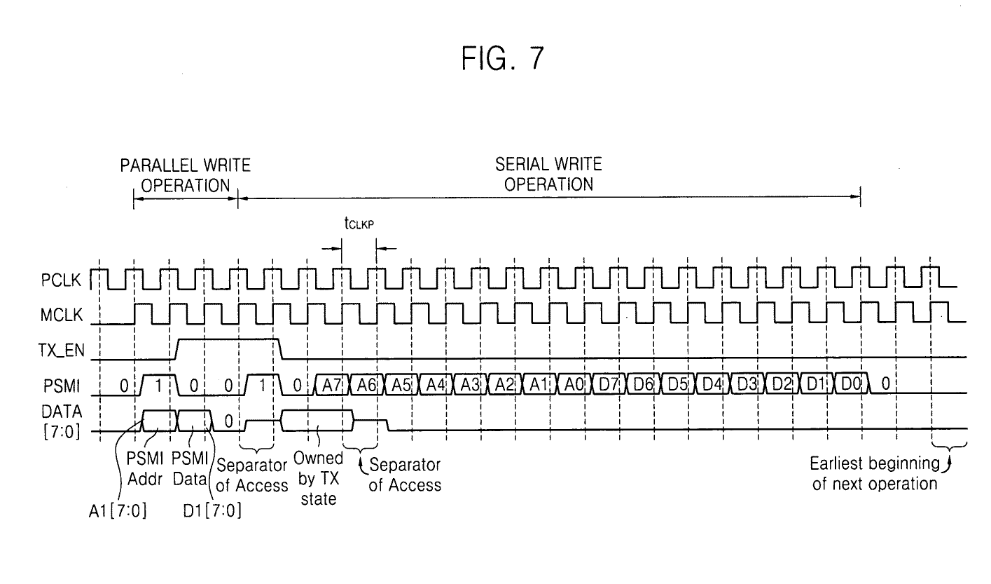

FIG. 7 is a timing diagram of a first write operation in parallel mode of the operational registers 60 of the PHY system 30 by the MAC system 20, followed by an attempt at a second write operation in parallel mode that is aborted and instead performed in serial mode, in the system illustrated in FIG. 1. Referring to FIG. 7, the MAC system 20 successfully initiates and performs a first write operation by delivering a first address A1[7:0] of a first operational register 60 of the PHY system 30 to be accessed, followed by delivering a first data D1[7:0] to be programmed in the operational register 60 of the PHY system that was accessed by the first address A1[7:0]. This first write operation is performed in a parallel mode, for example, according to the protocol described above in connection with FIG. 6.

The PHY system 30 responds by writing the received first operational register data D1[7:0] to the operation register 60 having the first address A1[7:0].

Continuing to refer to FIG. 7, during a next clock cycle of the MCLK clock, the MAC system 20 attempts to initiate a second write operation by outputting a “1” on the PSMI line 49 as a second synchronization bit SYNC. However, under the present example, the transmission enable TX_EN signal is active at this time. Since a requirement for an operational register management operation to be performed in parallel mode requires that the TX_EN be inactive, the operation is not permitted in parallel mode, since the data bus DATA[7:0] is presently unavailable for this purpose. As a result, the second write operation proceeds in serial mode, for example, according to the protocol described above in connection with FIG. 3. Returning to FIG. 7, accordingly, the MAC system 20 successfully initiates and performs a second write operation by delivering a second address A2[7:0] of a second operational register 60 of the PHY system 30 to be accessed on the PMSI line 49 in a serial manner, followed by delivering a second data D2[7:0] to be programmed in the operational register 60 of the PHY system that was accessed by the second address A2[7:0] on the PMSI line in a serial manner. During this time period, the data bus DATA[7:0] is available to the system for normal data transfer operations between the MAC system 20 and the PHY system 30.

After a time when the second write operation is initiated, in this example, the transmission enable TX_EN signal again becomes inactive, in which case, the data bus DATA [7:0] may again become available to the MAC-PHY system for operational register management in parallel mode.

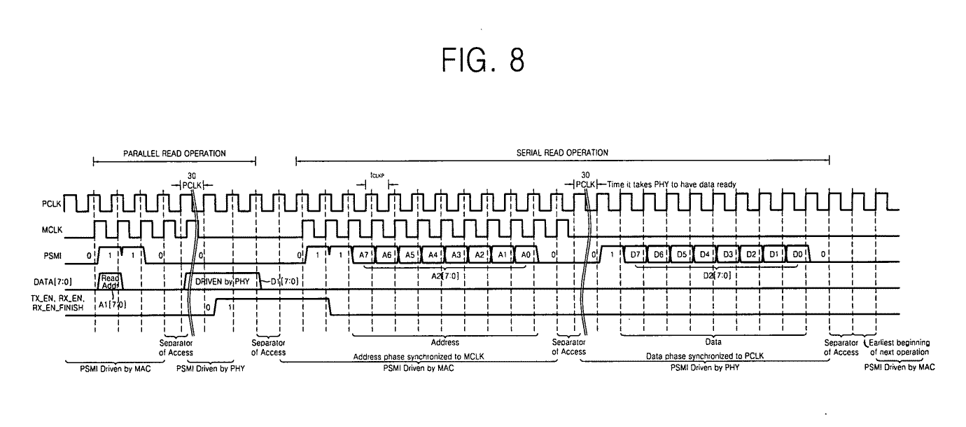

FIG. 8 is a timing diagram of a first read operation in parallel mode of the operational registers 60 of the PHY system 30 by the MAC system 20, that is aborted and instead performed in serial mode, in the system illustrated in FIG. 1. Referring to FIG. 8, the MAC system 20 attempts to initiate and perform a first read operation by delivering a first address A1[7:0] of a first operational register 60 of the PHY system 30 to be read. The first address A1[7:0] is provided from the MAC system 20 to the PHY system 30 on the data bus DATA[7:0] in parallel. At this time, the MAC system 20 is waiting for the PHY system 30 to provide the read register data. First data D1[7:0] then becomes available at a later time, and the data phase of the PHY register transaction read operation begins.

Continuing to refer to FIG. 8, in this example, during the data phase of the first read operation, one of the transmission enable TX_EN, receive enable RX_EN, and receive enable finish RX_EN_FINISH signals becomes active during the data phase. Since a requirement for an operational register management read operation to be performed in parallel mode requires that the TX_EN, RX_EN and RX_EN_FINISH signals be inactive, the read operation is no longer permitted in parallel mode, since the data bus DATA[7:0] is presently unavailable for this purpose. As a result, the first read operation is abandoned, and a second read operation proceeds in serial mode, for example, according to the protocol described above in connection with FIG. 2. Returning to FIG. 8, accordingly, the MAC system 20 successfully initiates and performs a second read operation by delivering a second address A2[7:0] of a second operational register 60 of the PHY system 30 to be accessed on the PMSI line 49 in a serial manner. The PHY system responds by delivering a second data D2[7:0] as the contents of the PHY register addressed by address A2[7:0] on the PMSI line in a serial manner. During this time period, the data bus DATA[7:0] is available to the system for normal data transfer operations between the MAC system 20 and the PHY system 30.

After a time when the second read operation is initiated, in this example, the transmission enable TX_EN, receive enable RX_EN and receive enable finish RX_EN_FINISH signals again becomes all inactive, in which case, the data bus DATA [7:0] may again become available to the MAC-PHY system for operational register management in parallel mode.

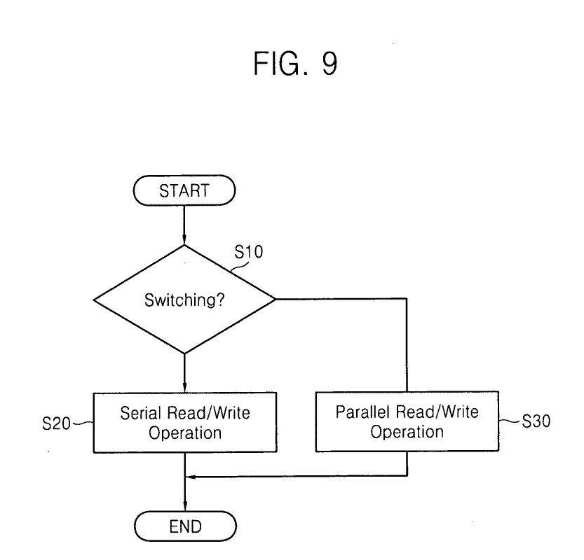

FIG. 9 is a flow diagram illustrating switching between operational register management in parallel mode and an serial mode. Referring to FIG. 9, a MAC_PHY interface (MPI) may perform operational register management operations in a serial mode (S20) or in a parallel mode (S30) in response the change of a setting of a bit or set of bits in a predetermined register (S10) of the operational registers 60 in the PHY system 30. In one example, the setting of a bit or set of bits in the MPI capabilities register or a MPI CONFIG register can determine the mode of operation for operational register management operations.

When the MAC-PHY interface performs operational register management operations in the parallel mode, several advantages are realized. For example, following a power loss operation, the operational registers 60 in the PHY system 30 may lose information, assuming the PHY registers to be volatile. Therefore, during a following wake-up operation, initialization of these registers by the MAC system 20 is required. Parallel mode operation allows the operational registers 60 to be initialized with greater efficiency as compared to the serial mode of operation.

In addition, the parallel mode of operation register management described herein utilizes pre-existing signal paths, that is, signal paths that are already common in systems that utilize serial mode of operation register management. Therefore, reconfiguration of the MAC-PHY system to accommodate parallel mode of operation register management does not require the addition of new interface signals.

Also, embodiments of the present inventive concept eliminate the need for parallel-td-serial conversion and serial-to-parallel conversion when a parallel PHY register transaction is performed, since the register address and register data signals are transferred in parallel, reducing gate count and therefore, reducing circuit size and circuit power consumption.

Further, embodiments of the present inventive concept allow for parallel mode operation when the parallel data bus DATA [7:0] is available, and reversion to the normal serial mode operation when the data bus DATA [7:0] is unavailable. Therefore, established serial mode operation register management is maintained.

While embodiments have been particularly shown and described with references to preferred embodiments thereof, it will be understood by those skilled in the art that various changes in form and details may be made herein without departing from the spirit and scope of the invention as defined by the appended claims.

What is claimed is:

1. A method of transferring signals between a media access controller (MAC) and a physical layer (PHY) on an interface that includes a parallel data bus for the transmission of data signals in parallel between the MAC and the PHY, comprising:
initiating, at the MAC, a PHY register transaction, by providing, at the MAC, a PHY register address in parallel on the parallel data bus and a control signal on a serial control signal line to request the PHY register transaction, the PHY register transaction comprising one of a PHY register write operation and a PHY register read operation;
in the event the control signal requests a PHY register write operation, the MAC next providing PHY register data signals in parallel on the parallel data bus to program a PHY register having the PHY register address; and
in the event the control signal requests a PHY register read operation, the PHY next providing PHY register data signals in parallel on the parallel data bus for the PHY register having the PHY register address.

2. The method of claim 1 wherein, in the event the control signal requests a PHY register write operation, the MAC further provides a data control signal on the serial control line to indicate the availability of the PHY register data signals on the parallel data bus.

3. The method of claim 1 wherein, in the event the control signal requests a PHY register read operation, the PHY further provides a data control signal on the serial control line to indicate the availability of the PHY register data signals on the parallel data bus.

4. The method of claim 1 wherein the control signal comprises a synchronization bit that indicates the initiation of a PHY register transaction, followed by a read/write bit that indicates whether the initiated PHY register transaction is a PHY register read operation or a PHY register write operation.

5. The method of claim 1 further comprising before or during the step of initiating, in the event the control signal requests a PHY register write operation and it is determined that the parallel data bus is not available for a PHY register transaction, the MAC instead provides a control signal on a serial control signal line to request the PHY register write operation followed by providing the PHY register address in serial on the serial control signal line.

6. The method of claim 1 further comprising, following the step of initiating, in the event the control signal requests a PHY register write operation and it is determined that the parallel data bus is no longer available for a PHY register transaction, the MAC continues providing a PHY register address in parallel on the parallel data bus and a control signal on a serial control signal line to request the PHY register write operation.

7. The method of claim 1 further comprising, in the event the control signal requests a PHY register read operation and it is determined that the parallel data bus is not available for a PHY register transaction, the PHY register read operation is aborted, and the MAC continues by providing a control signal on the serial control signal line to request the PHY register read operation followed by providing the PHY register address in serial on the serial control signal line.

8. The method of claim 1 wherein:
in the event a mode of operation of the PHY register transaction is determined as a parallel mode, the PHY register address and the PHY register data are provided between the PHY and the MAC in parallel on the parallel data bus, and further
in the event the mode of operation of the PHY register transaction is determined as a serial mode, the PHY register address and the PHY register data are provided between the PHY and the MAC in serial on the serial control signal line.

9. The method of claim 10 wherein the mode of operation of the PHY register transaction is determined as a data value of at least one bit of at least one of the PHY registers.

10. The method of claim 1 wherein the PHY register address comprises eight bits and the parallel data bus is eight-bits wide.

11. The method of claim 1 wherein the PHY register data comprises eight bits and the parallel data bus is eight-bits wide.

12. A data transmission system including a media access controller (MAC) and a physical layer (PHY) that transfer signals on an interface comprising:
a parallel data bus for the transmission of data signals in parallel between the MAC and the PHY;
a serial control line for the transmission of control signals between the MAC and the PHY; and
a controller configured to initiate, at the MAC, a PHY register transaction, by providing, at the MAC, a PHY register address in parallel on the parallel data bus and a control signal on the serial control signal line to request the PHY register transaction, the PHY register transaction comprising one of a PHY register write operation and a PHY register read operation, wherein
in the event the control signal requests a PHY register write operation, the MAC next provides PHY register data signals in parallel on the parallel data bus to program a PHY register having the PHY register address; and
in the event the control signal requests a PHY register read operation, the PHY next provides PHY register data signals in parallel on the parallel data bus for the PHY register having the PHY register address.

13. The system of claim 12 wherein, in the event the control signal requests a PHY register write operation, the controller is further configured to have the MAC further provide a data control signal on the serial control line to indicate the availability of the PHY register data signals on the parallel data bus.

14. The system of claim 12 wherein, in the event the control signal requests a PHY register read operation, the PHY further provides a data control signal on the serial control line to indicate the availability of the PHY register data signals on the parallel data bus.

15. The system of claim 12 wherein the control signal comprises a synchronization bit that indicates the initiation of a PHY register transaction, followed by a read/write bit that indicates whether the initiated PHY register transaction is a PHY register read operation or a PHY register write operation.

16. The system of claim 12 wherein the controller is further configured so that before or during the MAC initiating a PHY register transaction, in the event the control signal requests a PHY register write operation and it is determined that the parallel data bus is not available for a PHY register transaction, the MAC instead provides a control signal on a serial control signal line to request the PHY register write operation followed by providing the PHY register address in serial on the serial control signal line.

17. The system of claim 12 wherein the controller is further configured so that following the MAC initiating a PHY register transaction, in the event the control signal requests a PHY register write operation and it is determined that the parallel data bus is no longer available for a PHY register transaction, the MAC continues providing a PHY register address in parallel on the parallel data bus and providing a control signal on a serial control signal line to request the PHY register write operation.

18. The system of claim 12 wherein the controller is further configured so that, in the event the control signal requests a PHY register read operation and it is determined that the parallel data bus is not available for a PHY register transaction, the PHY register read operation is aborted, and the MAC continues by providing a control signal on the serial control signal line to request the PHY register read operation followed by providing the PHY register address in serial on the serial control signal line.

19. The system of claim 12 wherein:
in the event a mode of operation of the PHY register transaction is determined as a parallel mode, the controller is configured so that the PHY register address and the PHY register data are provided between the PHY and the MAC in parallel on the parallel data bus, and further
in the event the mode of operation of the PHY register transaction is determined as a serial mode, the controller is configured so that the PHY register address and the PHY register data are provided between the PHY and the MAC in serial on the serial control signal line.

20. The system of claim 19 wherein the mode of operation of the PHY register transaction is determined as a data value of at least one bit of at least one of the PHY registers.

21. The system of claim 12 wherein the PHY register address comprises eight bits and the parallel data bus is eight-bits wide.

22. The system of claim 12 wherein the PHY register data comprises eight bits and the parallel data bus is eight-bits wide.

23. A method of transferring signals between a media access controller (MAC) and a physical layer (PHY) on an interface that includes a parallel data bus for the transmission of data signals in parallel between the MAC and the PHY and that includes a serial control line for the transmission of control signals between the MAC and PHY, comprising:
setting a data value of at least one PHY register of the PHY to indicate one of a parallel mode and a serial mode of operation; and
performing a PHY register transaction in parallel on the parallel data bus in response to the data value of the PHY interface register indicating a parallel mode of operation; and
performing a PHY register transaction in serial on the serial control signal line in response to the data value of the PHY interface register indicating a serial mode of operation

24. The method of claim 23, further comprising:
initiating, at the MAC, a PHY register transaction, by providing, at the MAC, a PHY register address in parallel on the parallel data bus and a control signal on the serial control signal line to request the PHY register transaction, the PHY register transaction comprising one of a PHY register write operation and a PHY register read operation;
in the event the control signal requests a PHY register write operation, the MAC next providing PHY register data signals in parallel on the parallel data bus to program a PHY register having the PHY register address; and
in the event the control signal requests a PHY register read operation, the PHY next providing PHY register data signals in parallel on the parallel data bus for the PHY register having the PHY register address.

25. The method of claim 23 wherein, in the event the control signal requests a PHY register write operation, the MAC further provides a data control signal on the serial control line to indicate the availability of the PHY register data signals on the parallel data bus.

26. The method of claim 23 wherein, in the event the control signal requests a PHY register read operation, the PHY further provides a data control signal on the serial control line to indicate the availability of the PHY register data signals on the parallel data bus.

27. The method of claim 23 wherein the control signal comprises a synchronization bit that indicates the initiation of a PHY register transaction, followed by a read/write bit that indicates whether the initiated PHY register transaction is a PHY register read operation or a PHY register write operation.

28. The method of claim 23 further comprising before or during the step of initiating, in the event the control signal requests a PHY register write operation and it is determined that the parallel data bus is not available for a PHY register transaction, the MAC instead provides a control signal on a serial control signal line to request the PHY register write operation followed by providing the PHY register address in serial on the serial control signal line.

29. The method of claim 23 further comprising, following the step of initiating, in the event the control signal requests a PHY register write operation and it is determined that the parallel data bus is no longer available for a PHY register transaction, the MAC continues providing a PHY register address in parallel on the parallel data bus and a control signal on a serial control signal line to request the PHY register write operation.

30. The method of claim 23 further comprising, in the event the control signal requests a PHY register read operation and it is determined that the parallel data bus is not available for a PHY register transaction, the PHY register read operation is aborted, and the MAC continues by providing a control signal on the serial control signal line to request the PHY register read operation followed by providing the PHY register address in serial on the serial control signal line.

31. The method of claim 23 wherein:
in the event a mode of operation of the PHY register transaction is determined as a parallel mode, the PHY register address and the PHY register data are provided between the PHY and the MAC in parallel on the parallel data bus, and further
in the event the mode of operation of the PHY register transaction is determined as a serial mode, the PHY register address and the PHY register data are provided between the PHY and the MAC in serial on the serial control signal line.

32. The method of claim 23 wherein the PHY register address comprises eight bits and the parallel data bus is eight-bits wide.

33. The method of claim 23 wherein the PHY register data comprises eight bits and the parallel data bus is eight-bits wide.
